(19) United States
(12) Patent Application Publication
(10) Pub. No.: US 2015/0019251 A1
(43) Pub. Date: Jan. 15, 2015

(54) PRODUCT INFORMATION MANAGEMENT SYSTEM AND METHOD FOR USE IN CLINICAL TRIALS

(71) Applicant: Amerisourcebergen Specialty Group, Inc., Frisco, TX (US)

(72) Inventors: Chris Flori, Dallas, TX (US); Dustin Roller, Frisco, TX (US)

(21) Appl. No.: 14/498,831

(22) Filed: Sep. 26, 2014

Related U.S. Application Data
(63) Continuation-in-part of application No. 13/720,604, filed on Dec. 19, 2012.

(51) Int. Cl. G06Q 10/08; G06Q 50/22; G06K 7/10

(52) U.S. Cl. CPC G06Q 10/087; G06K 7/10009; G06Q 50/22
USPC 705/2; 705/28

(57) ABSTRACT

A product information management system includes at least one product cabinet in communication with a server. The at least one product cabinet is configured to store one or more product units each configured with a corresponding one or more RFID tags, and monitor an inventory of the one or more product units by wirelessly detecting the one or more RFID tags. The server is configured to receive product information associated with the one or more product units from the at least one product cabinet, store the product information, and transmit the product information to a network node associated with at least one vested entity associated with the one or more product units.

### CROSS REFERENCE TO RELATED APPLICATION

This patent application is a continuation-in-part that claims priority under 35 U.S.C. §120 to U.S. patent application Ser. No. 13/720,604 filed on Dec. 19, 2012, titled “PRODUCT INVENTORY INFORMATION SHARING SYSTEM AND METHOD”, which is incorporated herein by reference.

### TECHNICAL FIELD

The present disclosure is generally related to product information management and tracking systems, and more particularly, to a product information management system and method for use in a clinical trial or similar application.

### BACKGROUND

Product tracking is of importance to any manufacturing, distribution, or sales enterprise. It can be particularly important in the pharmaceutical area, where many products must be carefully identified and tracked from manufacture until administered to a patient. Typical known means of tracking pharmaceuticals involve manual record keeping and identifying products according to written labels. Inventory management and distribution also typically rely on a manual process of taking a physical inventory of product and manually ordering refills or restocking, while also eliminating product that is nearing or passed its expiry.

Another significant issue with pharmaceuticals is the high cost of maintaining an inventory of expensive drugs. Some drugs, such as those in a development or clinical trial stage, can cost several thousand dollars per dose. Because of the high cost of these drugs, managing and tracking each product becomes essential.

### SUMMARY

According to one embodiment, a product information management system includes at least one product cabinet in communication with a server. The at least one product cabinet is configured to store one or more product units each configured with a corresponding one or more RFID tags, and monitor an inventory of the one or more product units by wirelessly detecting the one or more RFID tags. The server is configured to receive product information associated with the one or more product units from the at least one product cabinet, store the product information, and transmit the product information to a network node associated with at least one vested entity associated with the one or more product units.

According to another embodiment, a method for product information management includes storing one or more product units each configured with a corresponding one or more RFID tags, monitoring an inventory of the one or more product units by wirelessly detecting the RFID tags, receiving product information associated with the one or more product units from at least one product cabinet, storing the product information, and transmitting the product information to a network node associated with at least one vested entity associated with the one or more product units.

According to yet another embodiment, a product information management system includes a server configured to receive product information associated with one or more product units from a plurality of product cabinets, each product cabinet configured to store one or more product units each configured with a corresponding one or more RFID tags and monitor an inventory of the one or more product units by wirelessly detecting the RFID tags; store the product information; and transmit the product information to a network node associated with at least one vested entity associated with the one or more product units.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example network topology of a product information management system according to this disclosure;

FIG. 2 illustrates an example cabinet according to this disclosure;

FIG. 3 illustrates an example product unit according to this disclosure;

FIG. 4 illustrates an example user interface that may be used with the cabinet of FIG. 2 according to this disclosure;

FIGS. 5A and 5B illustrate screen images in an example user portal according to this disclosure; and

FIG. 6 illustrates an example process for managing and sharing product and clinical trial information according to this disclosure.

### DETAILED DESCRIPTION

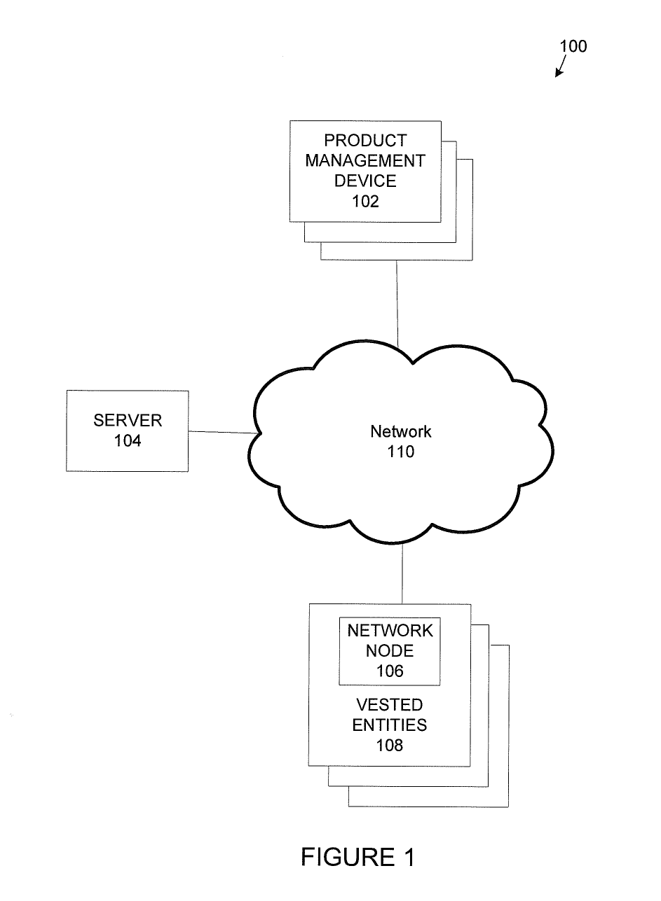

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with particular reference to the presented embodiments.

In medical clinical trials, such as those for the testing of pharmaceutical drugs, the ability to have the proper quantity of product at the right place and right time for the right patient is crucial to the success of the trial. In current clinical trial systems, many issues can arise that hinder this success. For example, in clinical trials, products are typically made in small batches; thus, with limited quantities, there is less room for error in getting the product in the right place. In clinical trials that include multiple locations, one location may not receive enough of a product, while another location may receive more than needed. These problems can exacerbate when a patient does not show up at a clinical trial location, or the patient shows up at the wrong clinical trial location. Also, poor product marking can lead to confusion as to what product is in each package. In such cases, a site investigator may have to travel from location to location to investigate these problems, make notes, and then return to a management office to resolve the issues. The resulting latency of the inventory information usually leads to significant problems.

To resolve these issues, embodiments of the present disclosure include a system and methods for real-time management of product inventories and product usage information with one or more entities, such as healthcare professionals, vested in the use of the product for which the inventory is maintained. Various embodiments may use a product management cabinet that tracks or otherwise maintains an ongoing status of product inventory and information about product usage in real time, and a server that stores the product information for use by the one or more vested entities. In some embodiments, the disclosed system and methods are suitable for use in a clinical trial application. It will be understood that the disclosed system and methods may be suitable for other applications as well.

FIG. 1 illustrates an example network topology of a product information managing system 100 according to this disclosure. The product information managing system 100 includes one or more product management devices 102, a server 104, and one or more network nodes 106 of one or more corresponding vested entities 108 that communicate through a network 110, such as the Internet. Each product management device 102 stores and maintains an inventory of one or more product units. As will be described in detail below, the server 104 periodically receives product information from each product management device 102 through the network 110. The server 104 stores the product information, and transmits the product information to network nodes 106 associated with one or more vested entities 108 associated with the product units.

Products stored in each product management device 102 may be any suitable type for which an ongoing, relatively up-to-date inventory may be maintained and shared with any entities vested in the product. In certain embodiments, the product may be a pharmaceutical product that treats an ailment of a patient. In a particular embodiment, the product may be a high-cost pharmaceutical product that must be carefully tracked for financial, inventory, or clinical trial purposes. In other embodiments, the product may include non-pharmaceutical products.

The vested entities 108 may include those entities having a vested interest in the use and inventory of the product. For products such as pharmaceutical products, these vested entities may include a healthcare professional who administers the pharmaceutical (e.g., a doctor or nurse), an office administrative professional responsible for inventory management (e.g., an office manager, accounting professional, or bookkeeper), a clinical trial administrator responsible for a clinical trial of the pharmaceutical product, a manufacturer or distributor that provides the pharmaceutical product to the patient, or any other suitable entity.

Each vested entity 108 may receive up-to-date inventory and usage information via its associated network node 106. The network nodes 106 may be any computing system having one or more processors that execute instructions stored in a memory. Examples of such a computing system include personal computers, mainframe computers, laptop computers, personal digital assistants, cellular telephones, and the like. Each network node 106 may include any type of application or portal (e.g., a web portal, a local computer application, or a mobile application or “app”) to access and interact with the inventory and usage information of one or more product management devices 102.

In one embodiment, the network node 106 used by a vested entity 108 may periodically receive product information from each product management device 102 via the server 104. In another embodiment, the network node transmits the product information to at least one vested entity associated with the product units in response to a request for the product information from the vested entity.

Access to the product information may be protected from illicit access via an authentication process. For example, the server 104 may use a password protected login session to restrict access to only registered vested entities 108. As another example, the server 104 may use a public-private key authentication architecture for automated, periodic access to information by network nodes 106 used by each vested entity 108.

In certain embodiments, the server 104 may maintain an account for each vested entity such that the type and level of product information may be allocated independently for each vested entity 108. For example, when the product is a pharmaceutical product used in a clinical trial, a clinical trial administrator may wish to maintain an accurate status of the amount of product used for ordering and of product effects and side effects for trial data compilation, while a healthcare professional may wish to know which patients (by name) received the product, and in what amounts, for patient care. Thus, the account associated with the clinical trial administrator may be allocated to receive only anonymized patient information and product inventory and effectiveness information for use with the clinical trial, while the healthcare professional may be allocated to receive product use information as well as detailed patient information in order to associate the pharmaceutical product with the patient's care.

In certain embodiments, information transmitted through the network 110 may be encrypted to maintain its integrity and/or to thwart its illicit use. For example, the encryption of information may reduce the possibility of its modification by sniffing packets transmitted by the product management device 102 and spoofing these packets with illicit data. As another example, the information may be encrypted for compliance with certain governmental privacy requirements, such as the Health Insurance Portability and Accountability Act (HIPAA), which requires that only certain authorized entities have access to medical records of the patients associated with the product management device 102.

The network 110 can be implemented using any known networking technology, such as a public or private network or as direct communications, and may be implemented using the Internet to communicate between each system. The network 110 can be implemented using multiple technologies, and can be implemented using multiple separate networks.

The product information managing system 100 as shown and described may include a single product management device 102 or may include multiple product management devices 102. The server 104 may perform overall inventory and usage management functions for these multiple product management devices 102. In general, the server 104 communicates with each product management device 102 to monitor its inventory on a regular basis. The server 104 can also monitor other status information of each product management device 102 according to one or more sensor devices configured in the product management device 102. The server 104 includes a database that maintains a current inventory of the product, the product inventory assigned to each product management device 102, and other information regarding each product management device 102.

The server 104 may also track all products from time of ordering and receiving into a warehouse, to placement in the product management device 102, to storage in the product management device 102, to removal from the product management device 102. The server 104 will periodically receive communications from each product management device 102 including the current inventory list, the consumed product list, and other information, such as product serial numbers, lot numbers, aging and expiration dates, and patient side effect information. These communications can be initiated by the server 104, by polling of the product management device 102, or can be initiated by the product management device 102. Such communications may occur in real-time as changes occur in the current inventory list or the consumed product list, or may occur as batch communications that reflect a number of changes over a period of time.

The server 104 may include a web server interface to allow management using a standard web browser interface. At least some data sent and received by the server 104 may be in extensible markup language (XML) format. The server 104 maintains at least one database for product inventory and usage data, which in a particular embodiment, is a structured query language (SQL) database.

The server 104 can also generate patient experience reports for clinical trials according to the product data from the product management device 102 of products that are consumed or used during the trial. This may include information correlating the use of each product with the patient's vital signs, symptoms, drug effects and side effects, and the like.

In various embodiments, the server 104 may create an order to have additional product added to the product management device 102 according to its inventory. The server 104 may be further configured to, in some embodiments, receive status data from the product management device 102, and send control instructions to the product management device 102. The server 104 may be further configured to, in some embodiments, analyze product consumption data according to inventory data received from the product management device 102, as described below.

Although FIG. 1 illustrates one example product information managing system 100 for managing and sharing product information with one or more vested entities 108, various changes may be made to FIG. 1. For example, in some embodiments, product information may be stored in a memory configured in the product management device 102 and periodically downloaded to a portable memory device, such as a flash memory card, which is then physically transported to, and accessed by a network node of a vested entity such that the communication network may not be necessary. In other embodiments, for security reasons, the product information may not be stored in the product management device 102. In yet other embodiments, each product management device 102, the server 104, and network nodes 106 administered by the vested entities 108 may exist as a single computing system in which communication of product information may be provided by internal system calls between each of its users.

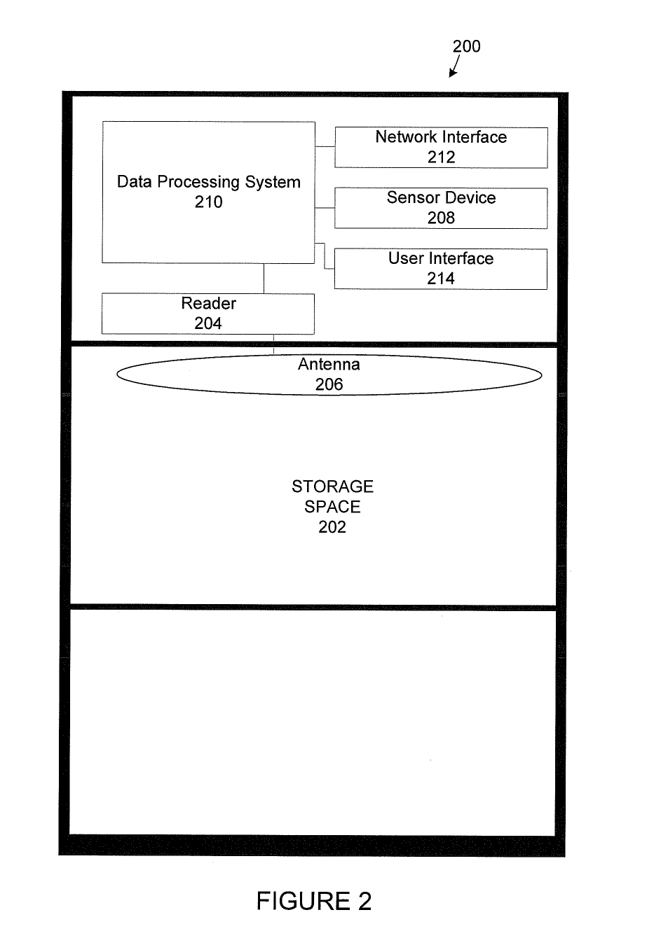

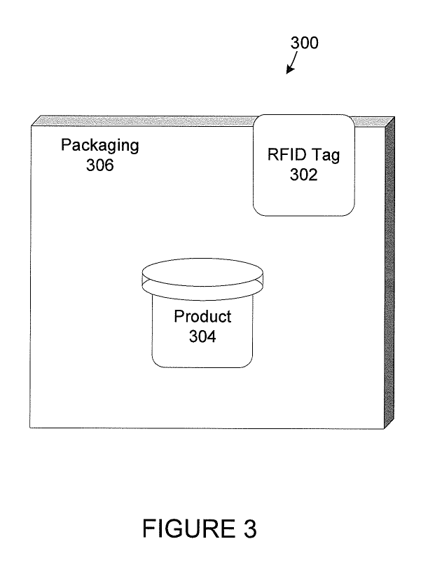

FIG. 2 illustrates an example cabinet 200 according to this disclosure. In an embodiment, the cabinet 200 functions as the product management device 102 as described above with reference to FIG. 1. The cabinet 200 is configured for use in a clinical trial and for placement in any of a number of different locations, such as a clinical setting (e.g., a hospital or doctor's office), or in a patient's home, or in any other suitable setting. The cabinet 200 has an internal storage space 202 for storage of one or more product units 300 (FIG. 3). The cabinet 200 may include a refrigeration and/or heating system for maintaining a temperature of the storage space at any desired temperature. For refrigerated use, a conventional refrigerator unit can be modified as described herein. For ambient-temperature use, a non-refrigerated cabinet can be used, or the refrigeration unit can be turned off or disconnected.

The cabinet 200 also includes a reader 204 to wirelessly and automatically detect and identify the contents of the cabinet 200. In one embodiment, the reader 204 is a radio-frequency identification (RFID) reader. The cabinet 200 includes one or more RFID antennas 206 coupled to the RFID reader 204 that scan the contents of the cabinet 200. The cabinet 200 may also include one or more optional sensor devices 208, such as a thermometer, a door-open sensor, a power-failure sensor and optional backup power supply, a GPS locating device, and other devices. In some embodiments, the cabinet 200 also has an attached RFID tag.

The cabinet 200 also includes a data processing system 210 that communicates with and controls the RFID reader 204. The cabinet data processing system 210 also includes communications software for communicating as described in detail below. The cabinet data processing system 210 also communicates with and controls the optional sensor devices 208 described above. The data processing system 210 may be implemented using any appropriate technology and components, configured to operate as described herein. The cabinet data processing system 210 generally includes one or more processors and one or more memory units for storing data as described herein.

The cabinet 200 also includes a network interface 212 for communication with other devices, such as the server 104 and/or network nodes 106 of vested entities 108 (See FIG. 1). The network interface 212 may be implemented using a wired communication medium such as an Ethernet or a telephone modem, or wireless communication medium such as a Global System for Mobile (GSM) communications architecture, Wi-Fi network (e.g., IEEE 802.11), a cable modem system, or any combination of these. In a particular embodiment, the network interface 212 communicates using an Internet Protocol. The network interface 212 allows the cabinet data processing system 210 to communicate with the server 104, and optionally with other cabinets 200 using a mesh networking topology, direct cabling, or other technologies. Communications between the cabinet data processing system 210 and the server 104 may be implemented using any suitable data communications technology, or any combination thereof. In embodiments where multiple cabinets 200 communicate with each other, they can be configured to communicate with the server 104 as a single unit with a combined product and usage information.

The cabinet 200 also includes a user interface 214 for interacting with a user of the cabinet 200. The user interface 214 includes one or more user input devices and one or more displays, such as a customizable electronic display. In a particular embodiment, the one or more input devices and the one or more displays could be integrated into one unit, such as a touch screen. The user interface 214 is connected to cabinet data processing system 210 and is configured to receive user input and display status or informational messages related to the status of the cabinet 200 or the product inventory, as described in greater detail below.

In use, the cabinet data processing system 210 performs periodic inventory scans, using the RFID reader 204, to uniquely identify each product unit 300 (See FIG. 3) stored in the cabinet 200. If a new identifier is found during any scan, the cabinet data processing system 210 notes the identifier and stores it to a current inventory list for that cabinet 200. Similarly, if a specific identifier is no longer detected during a periodic scan, because the product has been removed or the RFID tag has been damaged, the cabinet data processing system 210 notes the missing identifier and removes it from the current inventory list for the cabinet 200. The identifiers of such removed products are also stored in a “consumed product” list in the cabinet data processing system. Timestamp information may be recorded and included with the data records to indicate when a particular product was added or removed.

In this manner, the cabinet 200 is configured to monitor the inventory by wirelessly detecting the RFID tags. The cabinet 200 performs a periodic wireless scan to determine the current product units in the inventory, and determines that a product unit has been removed from the inventory when the RFID tag corresponding to the product unit is not detected for a predetermined amount of time. In some embodiments, the current inventory list and consumed product list can be displayed on a display of the user interface 214.

Of course, the references herein to the inventory list and consumed product list are not intended to specify a data structure for this information, as this information can be stored in any number of forms within the scope of the disclosed embodiments. The term “list” is simply used for convenient reference.

In certain embodiments, cabinet 200 may include a locking mechanism, or one or more individual locking compartments, to control access to the product. These locks can be any known technology, including key locks, digital keypad locks, biometric locks, etc. In some embodiments, the locking mechanism can be opened by entering a user authentication code via an input device of the user interface 214. The locking device can also be opened remotely if the cabinet data processing system 210 receives such a command from a particular node of the product information managing system 100.

The cabinet 200 may include a low-power or power-failure detection device and a backup power supply. When a power failure or low-power condition is detected, the cabinet 200 may generate an audible alarm, and can communicate with the server 104 to notify the existence of a problem.

FIG. 3 illustrates an example product unit 300 according to this disclosure. The product unit 300 described herein is configured for storage of pharmaceutical products; however, the systems and methods described herein can be applied to other products. Each product unit 300 includes an RFID tag 302 affixed to the product or its packaging, where the RFID tag 302 includes identifying information capable of being read by the RFID reader 204.

In a typical implementation, an individual product unit 300 includes the product 304 itself in an appropriate packaging 306, such as a box, bottle, blister pack, or the like. The packaging includes the RFID tag 302 that seals the package. The RFID tag 302 includes at least one unique identifier, such as a serial number, that can be used to link the product 304 in the corresponding packaging 306 with the particular RFID tag 302. That is, information about each product 304, the product packaging 306, and the corresponding RFID tag 302 can be linked together in a one-to-one or one-to-many relationship. A RFID reader (e.g., the RFID reader 204) can read information from the RFID tag 302, and a data processing system (e.g., the data processing system 210) can determine corresponding information about the product 304 in the packaging 306 associated with the RFID tag 314. Preferably, to open the package 306 for use of the product 304, the RFID tag 302 is damaged, at which point it can no longer be read by the RFID reader 204. For ease of reference, the term “serial number” will be used herein to refer to the unique identifier of the RFID tag 302, although those of skill in the art will recognize that any suitable style of unique identifier can be used.

Although the product unit 300 generally represents a generic product, there can be one or more actual products 304 identified as a product unit 300, which are packaged together. For example, in the pharmaceutical context, a single dose, pill, or pre-filled syringe can comprise a single product 304, but multiple ones of these can be packaged together as a single product unit 300, depending on the requirements for using, dispensing, or ordering for the product 304.

In a clinical trial, pharmaceutical products are typically investigational products that may lack commercial level identification. That is, the packaging of trial pharmaceuticals may be rather austere, where the quantity and the level of detail of information regarding the product in or on the package 306 may be very limited. Accordingly, the possibility of misinformation or confusion regarding a product package 306 and the product(s) 304 contained therein may be higher in a clinical trial as compared to commercially available products that include more detailed packaging. Additionally, in some clinical trial embodiments, each actual unit of the pharmaceutical (e.g., each pill) is serialized or otherwise uniquely identified by the manufacturer. This may be to track different dosages for different trial participants, or to track a series of different drugs for the same participant, or for any other suitable reason.

To address these issues, an informational link can be established between product identifiers of the actual product 304 (i.e., a particular pill or vial) contained in a product unit 300 and the RFID tag 302 attached to the product unit 300. The link can be stored as a data record for use by the data processing system 210, the server 104, or the network nodes 106. Thus, each drug unit can be identified by the serial number of the drug unit or by the RFID tag identifier. For example, in an embodiment, the data processing system 210 can determine that the cabinet 200 contains three 250 mg tablets of Pharmaceutical “A” simply by reading the RFID tags 302 within the cabinet 200 and cross-referencing the RFID tags 302 with product identifiers of the associated products.

In other clinical trial embodiments, the drug itself may not be serialized by the manufacturer, so the linking of the uniquely identifiable RFID tag 302 with the product unit 300 serves as a type of serialization. This information can be extremely important for regulation and governmental approval of the trial product. The informational link can be established at a predetermined stage in the product distribution process, such as when the RFID tag 302 is attached to the product unit 300.

Although FIGS. 2 and 3 illustrate one example cabinet 200 and product unit 300, various changes may be made to FIGS. 2 and 3. For example, the RFID tag 302 may wirelessly communicate with the reader 204 of the cabinet 200 using any suitable protocol. Additionally, the packaging 306 may be any suitable type, such as a bottle, jar, or a disposable capsule for containing the product 304.

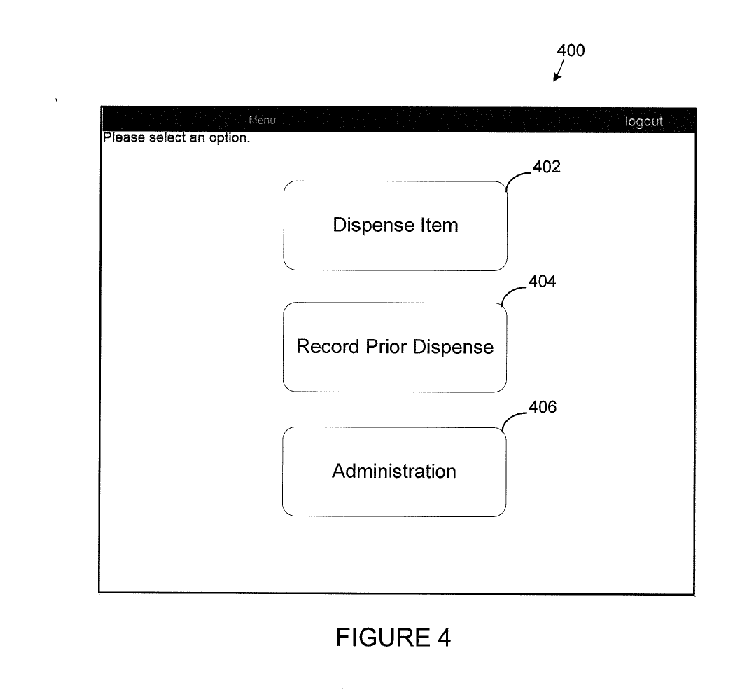

FIG. 4 illustrates an example user interface 400 that may be used with the cabinet 200 of FIG. 2 according to this disclosure. In some embodiments, the user interface 400 may represent the user interface 214 of FIG. 2. The user interface 400 may be disposed on an outer surface of the cabinet 200 and configured to document access to, and operations associated with, the cabinet 200 by one or more users. The access and various operations may be facilitated by one or more fields or controls (such as controls 402-406) displayed on the user input device 400. Information associated with the documented access and operations may be stored by the server 104 and transmitted to network nodes 106 of the vested entities 108.

The user interface 400 may include a refreshable display device, such as a touch screen that receives input as well as provides a display under the control of a controller, such as the data processing system (See FIG. 2). The user interface 400 may be configured on a door of the cabinet 200 for entry of user access information each time the door of the cabinet 200 is opened for access of one or more product units 300.

In an embodiment, the user interface 400 includes a Linux-based personal computing tablet that is installed on the cabinet 200. Use of the personal computing tablet may provide a refreshable display of the user interface 400 for alternatively displaying different fields for different product units or different product management operations.

The cabinet 200 may include a door lock that maintains the door of the cabinet 200 in a locked condition until user identification information is entered and the appropriate user is identified through the user interface 400. In this manner, a relatively quality level of the stored product inventory may be maintained for accurate analysis and processing.

As a failsafe feature, in the event of an emergency, such as a catastrophic fault of the data processing system 210, the lock may be disabled such that access may be provided even when user information is not inputted into user interface 400. For example, the door lock may be biased in the unlocked position and locked only when electrical power is actively provided to the door lock. Thus, access to the inner space of the cabinet 200 may be provided by merely unplugging the power cord to the cabinet 200 such that energizing power for locking the door of the cabinet 200 is removed. When power is again applied at a later time, the RFID reader 204 may again reconcile the inventory of product units 300 and send notification to one or more vested entities that the failsafe condition was used to access one or more product units.

The user interface 400 can include one or more fields or controls that may be selected or otherwise actuated by a user when the user desires to access or provide information regarding one or more product units from the cabinet 200. For example, as shown in FIG. 4, the user interface 400 includes a “Dispense Item” control 402, a “Record Prior Dispense” control 404, and an “Administration” control 406. Each control 402-406 is generally associated with a different product management function, such as entry of data associated with access to the cabinet 200, or when a product unit 300 (e.g., a pharmaceutical product) is accessed or removed from the cabinet 200. Although three controls are illustrated in the example user interface 400 in FIG. 4, it should be understood that any suitable type and number of controls may be displayed on the user interface 400. Similarly, actuation of each control 402-406 may generate the presentation of one or more submenus or sub-controls for options that exist hierarchically at a lower level.

In some embodiments, in order to access the functions or operations associated with the example user interface 400 depicted in FIG. 4, a user may be required to first provide user authentication information. For example, the user interface 400 may initially display a keypad for entering a personal identification number (PIN). The PIN could be a general use code or a code specific to a particular user.

Once the PIN is entered, the controls 402-406 shown in FIG. 4 are presented on the user interface 400. From this menu, the user has the option to select a function corresponding to one of the “Dispense Item” control 402, the “Record Prior Dispense” control 404, or the “Administration” control 406. Once the user selects the desired function, the user interface 400 may operate as described below.

In one aspect of operation, a user may select or otherwise actuate the “Dispense Item” control 402 when the user requires items from the cabinet 200. In some embodiments, once the user selects the “Dispense Item” control 402, a list of users authorized to access the cabinet 200 (e.g., a trial participant, a caregiver, a trial administrator, etc.) is presented for selection on the user interface 400. The list can be presented as a series of selectable boxes, a scrollable list, or in any suitable manner, depending on the number of users included in the list. Sorting of the list can be accomplished by any method including by last name, specialty, or any other specified type of group. The list can also be generated based on a user-entered PIN that would only permit display of users associated with the specific user PIN. Specific PINs associated with specific users could also be tracked for information tracking purposes.

Once the user is chosen from the user list, the user interface 400 may present an “unlocked” screen displaying the name of the user to verify a correct selection, and the cabinet 200 may unlock. This allows the user to select and remove one or more product units from the cabinet 200. In some embodiments, patient information associated with the removed product may also be provided by the user via the user interface 400. Such information may allow the information managing system 100 to link a removed product to the patient that used the product. In some embodiments, a user may also be permitted to return one or more previously removed items to the cabinet 200. Once the product unit(s) are pulled from, or returned to, the cabinet 200 and the door is closed, the data processing system 210 and the reader 204 verify the inventory by determining which RFID tags have been removed from (or added to) the cabinet 200.

In some embodiments, once the data processing system 210 determines which RFID tag(s) have been removed (or added), the user interface 400 displays a “verify” screen. The “verify” screen may include a listing of each product unit removed from (or added to) the cabinet 200 and any relevant descriptive information about each product unit, including a patient or user name, product unit name, item number, lot number, amount of product unit, or any other suitable product information desired to be displayed. Once the user verifies the listing of each product unit removed from (or added to) the cabinet 200, the user may confirm or cancel the transaction by actuating one or controls at the user interface 400.

The “Record Prior Dispense” control 404 may be selected to display an “unadjudicated items” list comprised of items that have been removed from the cabinet 200 with incomplete inventory information. Incomplete information can occur during power outages, connectivity outages, or any other situation where the necessary information is not input. Once the “unadjudicated items” list is displayed on the user interface 400, a user may update the list with the missing inventory information.

In addition to product and inventory information, the user interface 400 can be configured to provide and accept input of other clinical trial information. For example, in many clinical trials, each product may be associated with one or more interrogatives, questionnaires, or surveys. The questionnaires are provided to document the patient's experience with a product, including any side effects. The collection of information related to the patient experience with the product is very important in clinical trials. For example, in some clinical trials, the lack of adherence to providing this information in a timely and complete manner may disqualify a patient from a trial.

In one aspect of operation, a questionnaire associated with each dispensed product may be presented on the user interface 400. For example, at a predetermined point after a user has selected one of the dispense controls 402-404, the user interface 400 may present a questionnaire for the user to record information associated with the dispensed product. In some embodiments, this may include the user interface 400 presenting one or more multiple choice or short answer questions. The questions may include, for example, “Did the patient have any side effects after taking this drug?” or “Did the patient experience a headache after taking this drug?” or “Rate the patient's pain level before taking the drug (scale of 1-10).” The user may provide answers on the user interface 400 by checking a box, selecting an answer from a drop-down list, typing or writing an answer in a text box, or by any other suitable data entry method. The questions and answers associated with each questionnaire may be stored in a memory associated with the data processing system 210. Additionally or alternatively, one or more of the questions or answers may be transmitted to or received from the server 104 or the network nodes 106.

In some embodiments, the user interface 400 may present the questionnaire at the time the product is dispensed from the cabinet 200 in order to collect information about the patient's condition before the product is consumed. In other embodiments, the user interface 400 may present the questionnaire to the user for a previously dispensed product at the time the user selects the “Dispense Item” control 402 to dispense a new drug. That is, there may be no questionnaire presented at the time a first dose of a drug is dispensed from the cabinet 200; instead, the questionnaire for the first dose of the drug may be presented at the time the user dispenses a second dose of the drug from the cabinet 200. Such a delay may provide time for the user to determine if the first dose of the drug has caused any effects.

The “Administration” control 406 may be selected by a user in order to perform a number of different product administrative functions, such as restocking inventory, checking inventory, reviewing transaction history or user access history, managing expired or aging products, maintaining clinical trial questions and data, or any other suitable administrative function. Selection of the “Administration” control 406 may cause additional menu items, screens, or controls to be displayed on the user interface 400 to allow the user to perform the selected administrative function.

In some embodiments, the user interface 400 can be programmed to log out of the user session based on an idle timer, the cabinet 200 door closing, actuation of an “exit” button, or any other suitable event related to ending a current use of the cabinet 200.

Although FIG. 4 illustrates one example user interface 400 that may be used with the cabinet 200 of FIG. 2, various changes may be made to FIG. 4. For example, the user interface 400 may also be configured remotely from the cabinet 200 such that user access data, which is entered on the user interface 400, may be wirelessly transmitted to the data processing system 210. Alternatively, the user interface 400 may be electrically coupled to the cabinet 200 via a cord, such as an Ethernet cable, in which user access data is transferred from the user interface 400 to the data processing system 210.

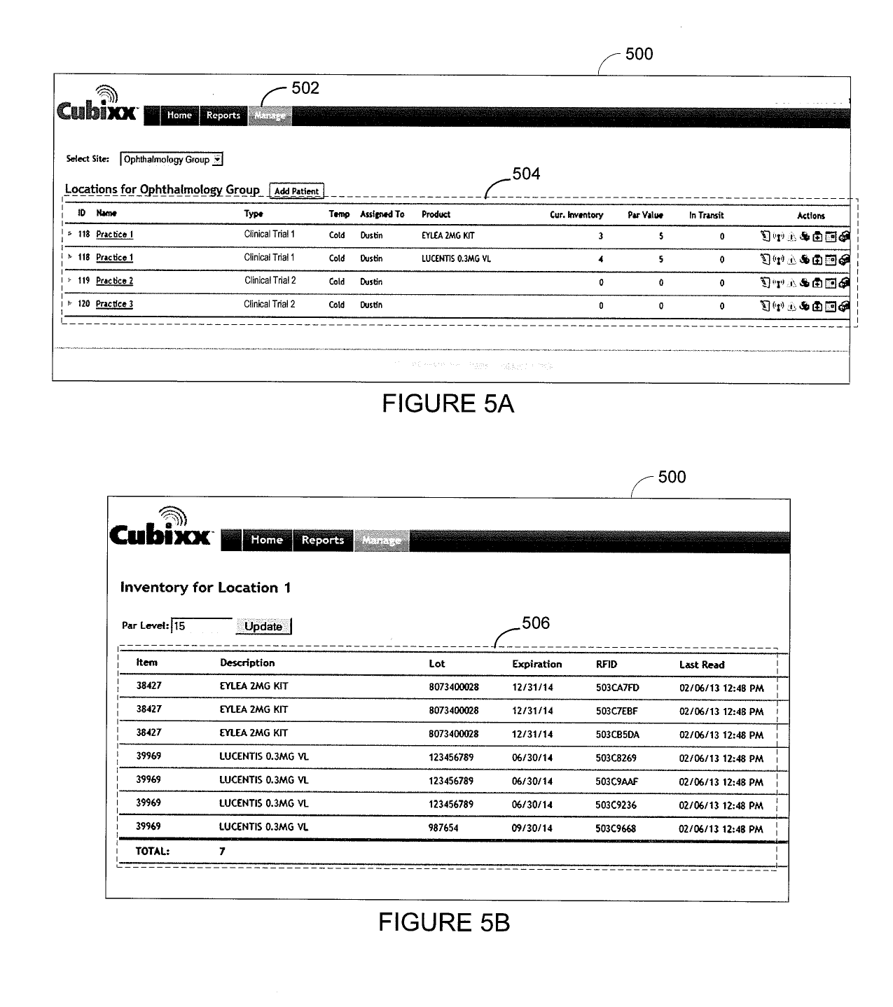

FIGS. 5A and 5B illustrate screen images in an example user portal 500, such as a web portal, that may be used with one or multiple cabinets 200 of FIG. 2 through the server 104 according to this disclosure. In some embodiments, the user portal 500 may be associated with a network node 106 of FIG. 1.

The user portal 500 provides a user the ability to monitor or manage products associated with one or multiple cabinets 200 at a single or multiple locations. In the example shown in FIGS. 5A and 5B, the user portal 500 presents the user with a number of different controls 502. As shown in FIG. 5A, upon actuation of the “Manage” control, the user portal 500 may display a list 504 of a plurality of cabinets 200 in the product information managing system 100. Upon selection of a specific cabinet 200 by the user, the user portal 500 retrieves information 506 regarding the selected cabinet 200 from the server 104 over the network 110 and displays the information 506 to the user, as shown in FIG. 5B. The retrieved information 506 may include current inventory values, expiration dates or other aging information, RFID tag numbers, lot numbers, item numbers, item descriptions, or any other suitable descriptive information about the contents of the selected cabinet 200. As a particular example, the user portal 500 may display cabinets 200 or cabinet locations that have inventory levels below a par value, in order to trigger a reordering process.

The user portal 500 may include functionality to allow the user to easily monitor dating of products in the cabinet 200. The user portal 500 can include one or more functions to inform the user that an expiration date for a product in the cabinet 200 is approaching. For example, the user portal 500 may display an inventory list sorted by expiration date, display a notification or alarm calling attention to an expired or nearly expired product, or use any other method for notifying the user. The user portal 500 can also be used to update information such as extending expiration dates when it is determined that a product has an extended shelf life. Such updated expiration date information for a product 304 can be easily transmitted to the cabinet 200 due to the predetermined matching of each RFID tag 302 associated with each product 304 with the serial number of each product 304.

Similarly, the user portal 500 can also include functionality to facilitate a recall on a product. For example, information related to serial numbers or lot numbers of recalled products may be provided from a manufacturer to the server 104. The server 104 is then able to determine which cabinets 200 contain one or more recalled products by comparing the recalled serial numbers or lot numbers with the product inventory information stored on the server 104 or received from each product management device 102. Information linking a recalled product and a cabinet 200 can then be displayed on the user portal 500. Notification of recalled products based on the serial number, lot number, or cabinet identifier allows the user to quickly identify which goods need to be returned or disposed of.

The user portal 500 may include other logistics tracking and inventory management and reporting functions. For example, using the user portal 500 a user may be able to create a report that details what product(s) have been removed from a cabinet 200 by which user and for which patient(s). Another report may be a product aging report in which products in each cabinet 200 are tracked by their expiration dates over time. Using such a report, a user (e.g., a clinical trial manager or administrator) may be able to determine which products are about to expire, or may be able to determine if newer products are being removed from the cabinet 200 before still viable older products are removed (this may suggest that product inventory is not being correctly rotated in the cabinet).

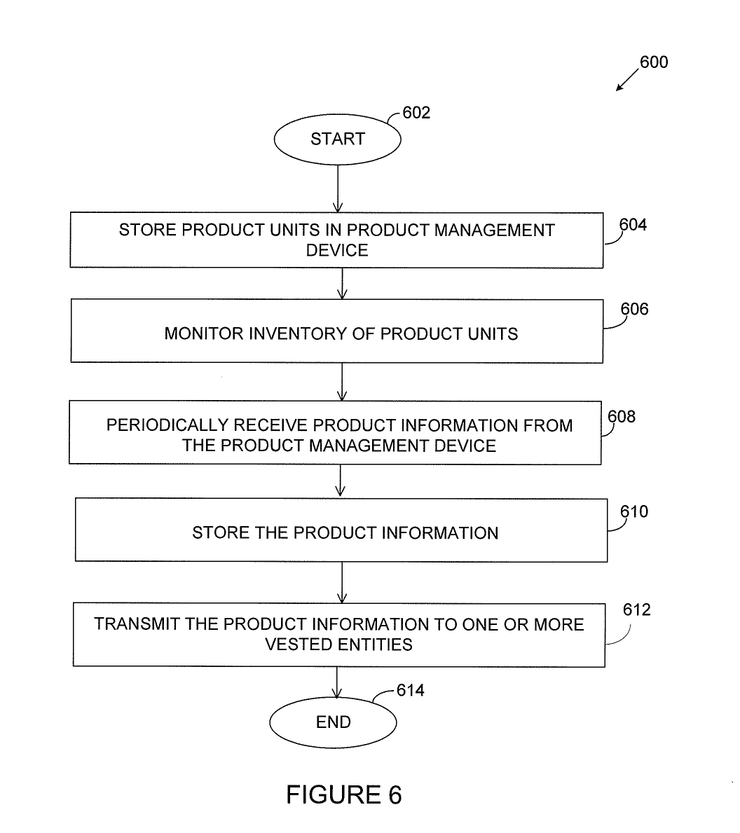

FIG. 6 illustrates an example process for managing and sharing product and clinical trial information according to this disclosure. In operation 602, the process is initiated.

In operation 604, one or more products units are stored in a product management device. In one embodiment, the product units include pharmaceutical products for use in a clinical trial. The product management device may include a cabinet 200 that is configured with a user input device for entry of product, caregiver, patient, or clinical trial information each time a product unit is removed from or added to the cabinet 200. In operation 606, the product management device monitors an ongoing inventory of the product units using RFID tags configured on each product unit stored in the cabinet 200.

In operation 608, a server 104 in communication with the product management device receives product information from the product management device. The product information may include inventory data associated with a quantity of product units currently in the cabinet 200 as well as information associated with usage of one or more pharmaceutical units during the clinical trial. In some embodiments, the server 104 may receive the product information substantially in real-time as changes to the product information occur. In other embodiments, the server 104 may receive the product information according to a reporting schedule or ad-hoc request.

In operation 610, the server 104 stores the obtained product information. The obtained product information may include inventory data, clinical trial information associated with the products, or both. Inventory data may be correlated with aging and expiration data. For example, an expired product list may be determined by correlating manufacturer expiration date information with current product inventory data obtained from the server 104. In such cases, information regarding an expired or nearly expired product could be transmitted back to the user interface 400, where a warning message may notify a patient not to consume a particular expired product. Using this information, vested entities, such as office managers, may provide enhanced management of inventory and clinical trial information.

In one embodiment, the server 104 may include a database for storage of the product and clinical trial information. The database may aggregate and organize the product and clinical trial information according to one or more criteria that may be useful to one or more of the vested entities. For example, the database may correlate an amount of product used in a particular cabinet compared to the par value, and may further include triggers that send appropriate messages to a vested entity (such as an office manager) through the network when certain inventory levels need restocking.

In operation 612, the server 104 transmits the product information to one or more entities vested in the product units. Examples of vested entities may include a healthcare professional who administers the pharmaceutical (e.g., a doctor or nurse), an office administrative professional responsible for inventory management (e.g., an office manager, accounting professional, or bookkeeper), a clinical trial administrator responsible for a clinical trial of the pharmaceutical product, a manufacturer or distributor that provides the pharmaceutical product to the patient, or any other suitable entity.

In one embodiment, a network node may include a portable wireless device, such as a cellular telephone or personal digital assistant (PDA), for remote access of product information. The network node may include executable software that displays fields for entry of user access data in a similar manner as shown in FIGS. 4, 5A, and 5B. Additionally, the executable software may include a mobile application (“app”) that may be executed under an operating system, such as the Android™ operating system executed on the wireless device, such as a smartphone.

Certain embodiments of the wireless device configured with such a mobile app may provide accurate reporting and storage of product and clinical trial information even when the user does not have ready access to the cabinet 200 or a desktop style computer for an extended period of time. The portable wireless device may be configured with a user interface similar to that shown above with respect to FIGS. 4, 5A, or 5B such that, whenever product or trial information changes in a cabinet 200, the information may be accessible at the portable wireless device.

In one embodiment, the server 104 transmits the product or trial information in response to a request for the information from a network node associated with the vested entity. That is, the product or trial information is transmitted to the vested entity upon a request for such information. In another embodiment, the server 104 periodically transmits the product or trial information to the network node of the vested entity. That is, the server 104 may implement a push-type protocol in which information is automatically transmitted to certain vested entities at recurring time periods. In still another embodiment, the server 104 transmits the product or trial information substantially in real-time as changes to the information are determined at the server 104. In any case, access to the product or trial information may be restricted by an authentication process such that only qualified entities may receive such information.

When use of the remote information management method as described above is completed, the process ends in operation 614.

It may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The various components and operations shown in each of the figures may be incorporated in other figures without departing from the scope of this disclosure. Modifications, additions, or omissions may be made to the systems, apparatuses, and methods described herein without departing from the scope of this disclosure. The components of the systems and apparatuses may be integrated or separated. Moreover, the operations of the systems and apparatuses may be performed by more, fewer, or other components. The methods may include more, fewer, or other operations. Additionally, operations may be performed in any suitable order. As used in this document, “each” refers to each member of a set or each member of a subset of a set.

Various functions described herein can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of the disclosure, as defined by the following claims.

What is claimed is:

1. A product information management system comprising:
at least one product cabinet configured to:
store one or more product units each configured with a corresponding one or more RFID tags; and
monitor an inventory of the one or more product units by wirelessly detecting the one or more RFID tags; and
a server configured to:
receive product information associated with the one or more product units from the at least one product cabinet;
store the product information; and
transmit the product information to a network node associated with at least one vested entity associated with the one or more product units.

2. The product information management system of claim 1, wherein the one or more product units comprise one or more pharmaceutical units for use in a clinical trial and the product information comprises information associated with usage of the one or more pharmaceutical units during the clinical trial.

3. The product information management system of claim 1, wherein the at least one product cabinet comprises a user interface disposed on an outer surface of the product cabinet.

4. The product information management system of claim 3, wherein the user interface is configured to display a questionnaire associated with patient usage of the one or more pharmaceutical units during the clinical trial and receive from a user one or more replies associated with the questionnaire.

5. The product information management system of claim 3, wherein the at least one product cabinet is further configured to receive expiration date or aging information for the one or more products units from the server and display the expiration date or aging information on the user interface.

6. The product information management system of claim 3, wherein:
each of the at least one product cabinet comprises a data processing system;
the user interface comprises one or more user controls configured to receive a user input; and
the data processing system is configured to update the product information based on the user input.

7. The product information management system of claim 1, wherein the network node comprises a user portal configured for user management of the product information received from the at least one product cabinet.

8. The product information management system of claim 7, wherein the at least one product cabinet comprises a plurality of product cabinets and the user portal is configured for user management of the product information received from the plurality of product cabinets.

9. The product information management system of claim 1, wherein each product cabinet is configured to determine a unique identifier of a product unit based on an identifier of the corresponding one or more RFID tags.

10. A method for product information management, the method comprising:
storing one or more product units each configured with a corresponding one or more RFID tags;
monitoring an inventory of the one or more product units by wirelessly detecting the RFID tags;
receiving product information associated with the one or more product units from at least one product cabinet;
storing the product information;
transmitting the product information to a network node associated with at least one vested entity associated with the one or more product units.

11. The method of claim 10, wherein the one or more product units comprise one or more pharmaceutical units for use in a clinical trial and the product information comprises information associated with usage of the one or more pharmaceutical units during the clinical trial.

12. The method of claim 11, wherein the at least one product cabinet comprises a user interface disposed on an outer surface of the product cabinet.

13. The method of claim 12, further comprising:
displaying, at the user interface, a questionnaire associated with patient usage of the one or more pharmaceutical units during the clinical trial and receiving from a user one or more replies associated with the questionnaire.

14. The method of claim 12, further comprising:
receiving expiration date or aging information for the one or more products units and displaying the expiration date or aging information on the user interface.

15. The method of claim 12, further comprising:
receiving a user input via one or more user controls of the user interface; and
updating the product information based on the user input.

16. The method of claim 10, further comprising:
determining a unique identifier of a product unit based on an identifier of the corresponding one or more RFID tags.

17. A product information management system comprising:
a server configured to:
receive product information associated with one or more product units from a plurality of product cabinets, each product cabinet configured to store one or more product units each configured with a corresponding one or more RFID tags and monitor an inventory of the one or more product units by wirelessly detecting the RFID tags;
store the product information; and
transmit the product information to a network node associated with at least one vested entity associated with the one or more product units.

18. The product information management system of claim 17, wherein the one or more product units comprise one or more pharmaceutical units for use in a clinical trial and the product information comprises information associated with usage of the one or more pharmaceutical units during the clinical trial.

19. The product information management system of claim 17, wherein the server is configured to transmit expiration date or aging information for the one or more products units to the at least one product cabinet, the expiration date or aging information configured to be displayed on a user interface at the at least one product cabinet.

20. The product information management system of claim 17, further comprising:
a user portal associated with the network node, the user portal configured for user management of the product information received from the at least one product cabinet.
